(19) United States
(12) Patent Application Publication
(10) Pub. No.: US 2007/0180405 A1
(43) Pub. Date: Aug. 2, 2007

(54) Information reproduction device and method, and computer program

(76) Inventors: Nobuyuki Takakuwa, Saitama (JP); Masanori Nakahara, Saitama (JP); Tohru Kanegae, Saitama (JP); Yasuko Fukuda, Saitama (JP); Takeshi Koda, Saitama (JP); Takao Sawabe, Saitama (JP)

Correspondence Address: YOUNG & THOMPSON, 745 SOUTH 23RD STREET, 2ND FLOOR, ARLINGTON, VA, 22202, US

(21) Appl. No.: 11/596,080

(22) PCT Filed: Apr. 21, 2005
(86) PCT No.: PCT/JP05/07616

§ 371 Date: Feb. 9, 2007

(30) Foreign Application Priority Data
May 11, 2004 (JP) 2004-141423

(51) Int. Cl. G06F 3/048

(52) U.S. Cl. 715/828

(57) ABSTRACT

An information reproduction device (300) reproduces an information recording medium (100) for recording content information, menu information multiplex-displayed during reproduction of content information, and display period information defining a display period of menu information. The information reproduction device includes menu display means (354) for multiplex-displaying the menu information according to the display period information and detection means for detecting whether menu information is multiplex-displayed. When the menu information is multiplex-displayed, the menu display means multiplex-displays the menu information even after the display period defined by the display period information has elapsed.

### TECHNICAL FIELD

The present invention relates to an information reproducing apparatus for and an information reproducing method of reproducing information from an information recording medium, such as an optical disc, on which various information, such as main-pictures or video, audio, and sub-pictures, can be recorded, and a computer program for reproduction control.

### BACKGROUND ART

A DVD is generalized as an optical disc on which various information, such as content information (i.e. main-pictures or video, audio, sub-pictures, or the like) and reproduction control information, are recorded. According to the DVD, with regard to one movie, for example, various audio, such as not only a stereophonic sound or a surround sound, but also an original English sound and a dubbed Japanese sound (or other sound), and various subtitles, such as Japanese subtitles and English subtitles (or other subtitles), (or other data) are multiplexed and recorded.

Moreover, in the DVD, a menu screen (or help screen) can be displayed in order to give an instruction to reproduce or stop video images, to use various functions of a player, or to change the setting of the player. The menu screen is constructed by displaying selectable buttons or the like, for example. Moreover, by a user selecting and executing the button, a corresponding command is executed, such as changing audio, subtitles, or viewpoint, and various setting.

Moreover, various technologies have been developed, in which the menu screens are displayed on different windows (refer to a patent document 1), the various operations selected by using the menu screen are imposed on the display screen of content data (refer to a patent document 2), or the display of such a menu screen is changed as occasion demands (refer to a patent document 3).

Patent document 1: Japanese Patent Application Laid Open NO. Hei 8-149407

Patent document 2: Japanese Patent Application Laid Open NO. Hei 8-251531

Patent document 3: Japanese Patent Application Laid Open NO. 2002-218394

### DISCLOSURE OF INVENTION

### Subject to be Solved by the Invention

By the way, for example, the standard of the DVD or the like defines the menu screen such that its displayable period is controlled in accordance with the reproduction time point of main video images. Therefore, after the displayable period, the user cannot perform the operation by using the menu screen, so that there is a technical problem of lack of convenience. If it is desired to perform the operation using the menu screen even after the displayable period, it is necessary to rewind the main picture or video, for example, so that it is hard to say that it is excellent in convenience for the user.

In order to solve the above-mentioned conventional problem, it is therefore an object of the present invention to provide an information reproducing apparatus and an information recording method, which enable the display of a highly convenient menu screen, and a computer program for reproduction control.

### Means for Solving the Subject

(Information Reproducing Apparatus)

The above object of the present invention can be achieved by an information reproducing apparatus for reproducing information on an information recording medium on which content information, menu information which is multiplex-displayed during reproduction of the content information, and display period information which defines a display period of the menu information are recorded, the information reproducing apparatus provided with: a menu displaying device for multiplex-displaying the menu information on the basis of the display period information; and a detecting device for detecting whether the menu information is multiplex-displayed, the menu displaying device multiplex-displaying the menu information, even after the display period defined by the display period information elapses, if it is detected by the detecting device that the menu information is multiplex-displayed.

According to the information reproducing apparatus of the present invention, there are recorded on the information recording medium: the content information including a movie or the like, for example; and the menu information including the menu screen for performing various operations. The menu information is information for displaying the menu screen which is multiplex-displayed together with the content information, during the reproduction of the content information. The menu information is recorded on the information recording medium with the display period information. Therefore, the menu displaying device usually multiplex-displays the menu information (specifically, the menu screen) in the display period defined by the display period information.

Particularly in the present invention, the detecting device is provided. The detecting device detects whether the menu information is multiplex-displayed. Then, if it is detected by the detecting device that the menu information is multiplex-displayed, the menu displaying device continues the multiplex-display of the menu screen, even after the display period defined by the display period information elapses.

By this, it is possible to prevent such a disadvantage that the menu information is not multiplex-displayed after the display period defined by the display period information elapses, and thus a user cannot perform the desired various operations. Namely, the user can preferably or comfortably continue the various operations, even after the display period defined by the display period information elapses.

Consequently, according to the information reproducing apparatus, it is possible to display (particularly, multiplex and display) the highly convenient menu screen.

In one aspect of the information reproducing apparatus of the present invention, it is further provided with an instructing device. The instructing device is constructed to give an instruction to extend the display period of multiplex-displaying the menu information. Namely, the user of the information reproducing apparatus of the present invention can give the instruction to continue the multiplex-display of the menu information. Namely, the user of the information reproducing apparatus of the present invention can give the instruction to continue the multiplex-display of the menu information. Therefore, if the user desires to multiplex-display the menu information, by giving the instruction to extend by using the instructing device, it is possible to continue the multiplex-display of the menu information without change.

In another aspect of the information reproducing apparatus of the present invention, the instructing device further gives at least an instruction to non-display (hide) the menu information which is multiplex displayed after the display period defined by the display period information elapses.

According to this aspect, not only the instruction to extend the display of the menu information but also the instruction to hide it can be given, so that it is possible to display the menu which is easier to use and highly convenient for the user.

In another aspect of the information reproducing apparatus of the present invention, the instructing device further gives an instruction relating to the display period of the menu information which is multiplex-displayed after the display period defined by the display period information elapses.

According to this aspect, it is possible to extend the display of the menu information by specifying the display period that the user desires, so that it is possible to display the menu which is easier to use and highly convenient for the user.

In another aspect of the information reproducing apparatus of the present invention, it is further provided with a storing device for storing one menu information which is multiplex-displayed.

According to this aspect, by storing the menu information in the storing device, it is possible to multiplex-display the menu information even in the reproduction of the content information, without burdening the reproduction of the content information.

In an aspect of the information reproducing apparatus provided with the storing device, as described above, it may be further provided with a controlling device for controlling the storing device not to store another menu information which is to be multiplex-displayed next to the one menu information, even after the display period defined by the display period information elapses, if the display period of multiplex-displaying the menu information is extended.

By virtue of such construction, it is possible to prevent such a disadvantage that another menu information, which is different from the menu information whose display period is extended, is mistakenly reproduced (i.e. multiplex-displayed).

(Information Reproducing Method)

The above object of the present invention can be also achieved by an information reproducing method of reproducing information on an information recording medium on which content information, menu information which is multiplex-displayed during reproduction of the content information, and display period information which defines a display period of the menu information are recorded, the information reproducing method provided with: a menu displaying process of multiplex-displaying the menu information on the basis of the display period information; a detecting process of detecting whether the menu information is multiplex-displayed; and a controlling process of controlling the menu displaying process to multiplex-display the menu information, even after the display period defined by the display period information elapses, if it is detected in the detecting process that the menu information is multiplex-displayed.

According to the information reproducing method of the present invention, it is possible to receive the same benefits as those of the information reproducing apparatus of the present invention.

Incidentally, in response to the various aspects of the information reproducing apparatus of the present invention, the information reproducing method of the present invention can also adopt various aspects.

(Computer Program)

The above object of the present invention can be also achieved by a computer program for reproduction control for controlling a computer provided in the above-mentioned information reproducing apparatus of the present invention (including its various aspects), the computer program making the computer function as at least one portion of the menu displaying device and the instructing device.

According to the computer program for reproduction control of the present invention, the above-mentioned information reproducing apparatus of the present invention can be relatively easily realized as a computer reads and executes the computer program from a program storage device, such as a ROM, a CD-ROM, a DVD-ROM, and a hard disk, or as it executes the computer program after downloading the program through a communication device.

Incidentally, in response to the various aspects of the above-mentioned information reproducing apparatus of the present invention, the computer program for reproduction control of the present invention can also adopt various aspects.

The above object of the present invention can be also achieved by a computer program product in a computer-readable medium for tangibly embodying a program of instructions executable by a computer provided in the above-mentioned information reproducing apparatus of the present invention (including its various aspects), to make the computer function as at least one portion of the menu displaying device and the instructing device.

According to the computer program product of the present invention, at least one portion of the menu displaying device and the instructing device of the present invention described above can be embodied relatively readily, by loading the computer program product from a recording medium for storing the computer program product, such as a ROM (Read Only Memory), a CD-ROM (Compact Disc - Read Only Memory), a DVD-ROM (DVD Read Only Memory), a hard disk or the like, into the computer, or by downloading the computer program product, which may be a carrier wave, into the computer via a communication device. More specifically, the computer program product may include computer readable codes to cause the computer (or may comprise computer readable instructions for causing the computer) to function as at least one portion of the menu displaying device and the instructing device of the present invention described above These effects and other advantages of the present invention will become more apparent from the following embodiment.

As explained above, according to the information reproducing apparatus, it is provided with: the menu displaying device; and the detecting device, and according to the information reproducing method, it is provided with: the menu displaying process; the detecting process; and the controlling process. Therefore, it is possible to display the highly convenient menu screen.

### BRIEF DESCRIPTION OF DRAWINGS

FIG. 1 is a block diagram conceptually showing the basic structure of an embodiment of the information reproducing apparatus of the present invention.

FIG. 2 is a schematic diagram conceptually showing the specific structure of an instruction button owned by the information reproducing apparatus in the embodiment.

FIG. 3 is an explanatory diagram conceptually showing, on a reproduction time axis, a relationship between content data and menu data recorded on an optical disc on which reproduction is performed by the information reproducing apparatus in the embodiment.

FIG. 4 is a schematic diagram conceptually showing an actual menu screen.

FIG. 5 is a flowchart conceptually showing the reproduction operation of the information reproducing apparatus in the embodiment (an operation of reproducing the content data and an operation of reproducing the menu data).

FIG. 6 is an explanatory diagram conceptually showing an aspect of a menu display operation performed by the information reproducing apparatus in the embodiment.

FIG. 7 is an explanatory diagram conceptually showing an aspect of the menu display operation performed by an information reproducing apparatus in a comparison example.

FIG. 8 is an explanatory diagram conceptually showing a more specific aspect of the menu display operation performed by the information reproducing apparatus in the embodiment.

### DESCRIPTION OF REFERENCE CODES

100 optical disc
300 information reproducing apparatus
312 instruction button
313 ON button
314 OFF button
315 KEEP button
353 signal reproducing device
354 CPU
355 memory

### BEST MODE FOR CARRYING OUT THE INVENTION

Hereinafter, the best mode for carrying out the present invention will be explained in each embodiment in order, with reference to the drawings.

Hereinafter, with reference to the drawings, the embodiment of the information reproducing apparatus of the present invention will be explained.

(Basic Structure)

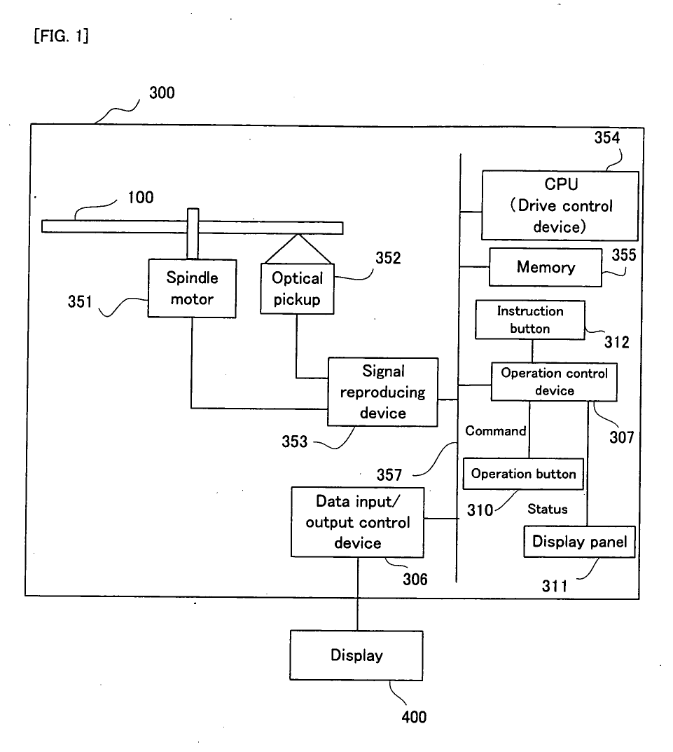

Firstly, with reference to FIG. 1, an explanation will be given for the basic structure of an embodiment of the information reproducing apparatus of the present invention. FIG. 1 is a block diagram conceptually showing the basic structure of the information reproducing apparatus in the embodiment. Incidentally, an information reproducing apparatus 300 has a function of reproducing various data (e.g. content data and menu data, etc.) recorded on the optical disc 100.

The information reproducing apparatus 300 is provided with: an optical disc 100; a spindle motor 351; an optical pickup 352; a signal reproducing device 353; a CPU (drive control device) 354; a memory 355; a data input/output control device 306; and operation button 310; a display panel 311; an instruction button 312; and a bus 357.

The spindle motor 351 is intended to rotate and stop the optical disc 100, and operates upon accessing the optical disc. More specifically, the spindle motor 351 is constructed to rotate and stop the optical disc 100 at a predetermined speed, under spindle servo from a not-illustrated servo unit or the like.

The optical pickup 352 is intended to perform the recording/reproduction with respect to the optical disc 100, and is provided with a laser device, a lens, and the like. More specifically, the optical pickup 352 irradiates the optical disc 100 with a light beam, such as a laser beam, as reading light with a first power upon reproduction, and as writing light with a second power upon recording, with it modulated.

The signal reproducing device 353 controls the spindle motor 351 and the optical pickup 352, to reproduce the various data recorded on the optical disc 100.

The memory 355 is one specific example of the “storing device” of the present invention, and is used in the general data processing on the disc drive 300, including a buffer area for the data, an area used as an intermediate buffer when the data read by the optical pickup 352 is converted into the data that can be used on the signal reproducing device 353, and the like. Moreover, the memory 355 is provided with: a ROM area into which a program for performing an operation as a recording device is stored; a buffer used for compression/decompression (or encoding/decoding) of data; a RAM area into which a parameter required for the operation of the program or the like is stored; and the like.

The CPU (drive control device) 354 is connected to the signal reproducing device 353 and the memory 355 through the bus 357, and controls the entire information reproducing apparatus 300 by giving an instruction to each controlling device. In general, software for operating the CPU 354 is stored in the memory 355.

The data input/output control device 306 controls the input/output of the data from/to the exterior on the information reproducing apparatus 300, to thereby perform storage to and export from the buffer on the memory 355. If the input/output of the data is an input/output of a video signal, the data input/output control device 306 compresses (encodes) the data received from the exterior in a MPEG format, for example, and outputs it to the memory 355, upon data inputting. Upon data outputting, it decompresses (decodes) the encoded data in the MPEG format or the like received from the memory 355, and outputs it to the exterior.

The operation control device 307 receives an operation instruction and performs display with respect to the information reproducing apparatus 300, and transmits an instruction by the operation button 310, such as an instruction to record or reproduce, to the CPU 354, and outputs the operation state of the information reproducing apparatus 300, such as during recording and during reproduction, to the display panel 311, such as a fluorescent tube and a liquid crystal panel.

Household equipment, as one example of the information reproducing apparatus 300 as explained above, is recorder equipment for recording and reproducing video images, for example. The recorder equipment records a video signal from a broadcast reception tuner and an external connection terminal, onto a disc, and outputs the video signal reproduced from the disc to external display equipment, such as a television. The operation as the recorder equipment is performed by executing a program stored in the memory 355, on the processor 354.

Particularly in the embodiment, the information reproducing apparatus 300 is provided with the instruction button 312, which is one specific example of the “instructing device” of the present invention. The instruction button 312, as described later, is constructed to input various instructions about the display (particularly, multiplex-display) of the menu screen shown on a display 400 connected to the data input/output control device 306. In particular, it is constructed to input an instruction to extend (or maintain) the display of the menu screen.

Incidentally, the menu screen is a display screen (display content) for performing the various operations, and is displayed with contents on the display 400 by reproducing the menu data (menu information) recorded on the optical disc 100. It includes various menu screens, such as a menu screen for allowing the operation about the reproduced content data (content information), i.e. about the displayed contents, a menu screen for allowing the operation about the loaded optical disc 100, and a menu screen for allowing the operation about the information reproducing apparatus 300 itself, and the like, for example.

As the display 400, various displays can be used, such as a liquid crystal display, a plasma display, a CRT (Cathode Ray Tube), an organic EL (Electro Luminescence) display, and a projector, for example.

One specific example of the instruction button 312 in the case where it is constructed as hardware, for example, will be explained with reference to FIG. 2. FIG. 2 is a schematic diagram conceptually showing the specific structure of the instruction button 312.

As shown in FIG. 2, the instruction button 312 is provided with: an ON button 313; an OFF button 314; and a KEEP button 315.

The ON button 313 is a button for outputting an instruction to display the menu screen described later. Namely, by the user of the information reproducing apparatus 300 pressing the ON button 313, the menu screen can be displayed on the display 400 with the contents, for example.

The OFF button 314 is a button for outputting an instruction not to display the menu screen described later. Namely, by the user pressing the OFF button 314, the menu screen currently displayed on the display 400 can be hidden (i.e. in a not-displayed condition).

The KEEP button 315 is a button for outputting an instruction to extend the display of the menu screen described later. Namely, by the user pressing the KEEP button 315, the menu screen currently displayed on the display 400 can be continuously displayed (or the display of the menu screen can be extended). For example, even after the period that the menu screen is to be originally displayed elapses, the menu screen can be continuously displayed if the KEEP button 315 is pressed.

As the instruction button 312, specifically, it is possible to use various operation buttons (or panel) mounted on the information reproducing apparatus 300, a remote controller, a touch panel, a mouse, a keyboard, an audio inputting apparatus, a motion sensor, or other various inputting apparatuses, or the like.

Incidentally, the structure as the instruction button 312 is not necessarily limited to the one shown in FIG. 2. For example, it may be the instruction button 312 provided only with the ON button 313 and the OFF button 314. In this case, it is only necessary to construct it to function as the KEEP button 315 by pressing the ON button 313 twice in a row (or, for example, keep pressing it for a certain time), for example. In short, if capable of functioning at least as the KEEP button 315, any specific structure can be adopted to function as the instruction button 312 in the embodiment.

(Basic Concept of Menu Display)

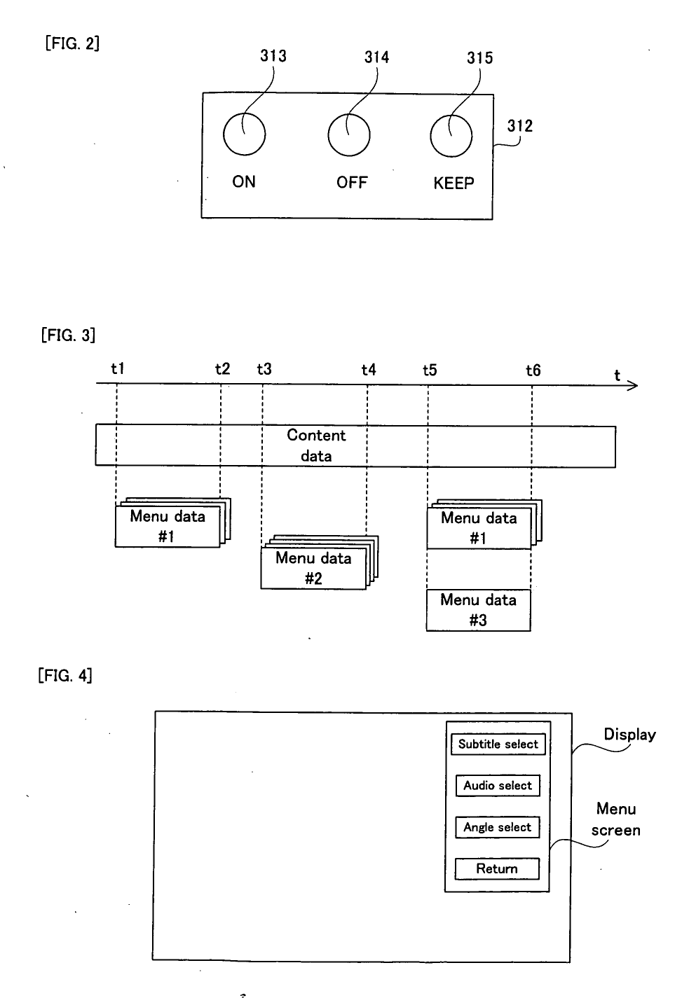

Next, the basic concept of the display of the menu screen will be explained with reference to FIG. 3 and FIG. 4. FIG. 3 is an explanatory diagram conceptually showing, on a reproduction time axis, a relationship between the content data and the menu data recorded on the optical disc 100 on which the reproduction is performed by the information reproducing apparatus in the embodiment. FIG. 4 is a schematic diagram conceptually showing the actual menu screen.

As shown in FIG. 3, the content data recorded on the optical disc 100 is recorded to be a continuous stream on the reproduction time axis. By reproducing the content data by using the above-mentioned information reproducing apparatus 300, it is possible to display the contents, such as a movie, a TV program, and various video image materials, on the display 400.

Then, the menu data is recorded on the optical disc 100 so as to display the menu screen with superimposing the menu screen on the contents to be reproduced. Specifically, the menu data is recorded on the optical disc 100 with period information (display period information) indicating a period in which the menu screen can be displayed.

For example, in FIG. 3, menu data #1 is recorded on the optical disc 100 with period information indicating that a menu screen associated with the menu data #1 (hereinafter referred to as a “menu screen #1”, as occasion demands) can be displayed in periods between time points t1 and t2, and between time points t5 and t6. Moreover, menu data #2 is recorded on the optical disc 100 with period information indicating that a menu screen associated with the menu data #2 (hereinafter referred to as a “menu screen #2”, as occasion demands) can be displayed in a period between time points t3 and t4. Moreover, menu data #3 is recorded on the optical disc 100 with period information indicating that a menu screen associated with the menu data #3 (hereinafter referred to as a “menu screen #3”, as occasion demands) can be displayed in a period between the time points t5 and t6.

Then, each menu data may be constructed such that it can display a plurality of selectable menu screens, as occasion demands. For example, it may be constructed such that the menu data #1 includes data for displaying three menu screens and that the three menu screens can be changed and displayed on the display, as occasion demands.

FIG. 4 shows one example of the menu screen actually displayed on the display by using the menu data.

As shown in FIG. 4, the menu screen is displayed on the display, including a subtitle select button, an audio select button, an angle select button, and a return button. During the display of the menu screen, the display of the contents, such as a movie and a TV program, (i.e. the reproduction of the data), is also performed.

Then, by the user selecting the subtitle select button, for example, another menu screen for performing an operation about the subtitle selection is displayed. Moreover, by the user selecting the audio select button, for example, another menu screen for performing an operation about the audio selection is displayed. Moreover, by the user selecting the return button, for example, a menu screen to be displayed one before the current menu screen is displayed. Or, by the user selecting the return button, for example, if there is no menu screen to be displayed one before the current menu screen, the current menu screen is continuously displayed.

In order to display the menu screen on the display 400, it is only necessary to press the ON button 313 explained in FIG. 2. For example, if the menu data shown in FIG. 3 is recorded on the optical disc 100, if the ON button 313 is pressed in the period between the time points t1 and t2, the menu screen #1 is displayed on the display 400. Moreover, if the ON button 313 is pressed in the period between the time points t3 and t4, the menu screen #2 is displayed on the display 400. Moreover, if the ON button 313 is pressed in the period between the time points t5 and t6, the menu screen #1 or #3, or another menu screen for selecting which menu screen is to be displayed, or the like, is displayed. Incidentally, even if the ON button 313 is pressed in a period between the time points t2 and t3, or the time points t4 and t5, the menu screen is preferably not displayed, because there is no menu data set to be displayable during this period.

Moreover, by pressing the OFF button 314 while each menu screen is displayed, it is possible to hide the menu screen (i.e. make it not-displayed). Of course, if the period that each menu screen can be displayed, defined by the period information, has elapsed, the menu screen automatically becomes not-displayed, for example. For example, if the time point t2 has passed while the menu screen #1 is displayed, the menu screen #1 becomes not-displayed. Moreover, if the time point t4 has passed while the menu screen #2 is displayed, the menu screen #2 becomes not-displayed.

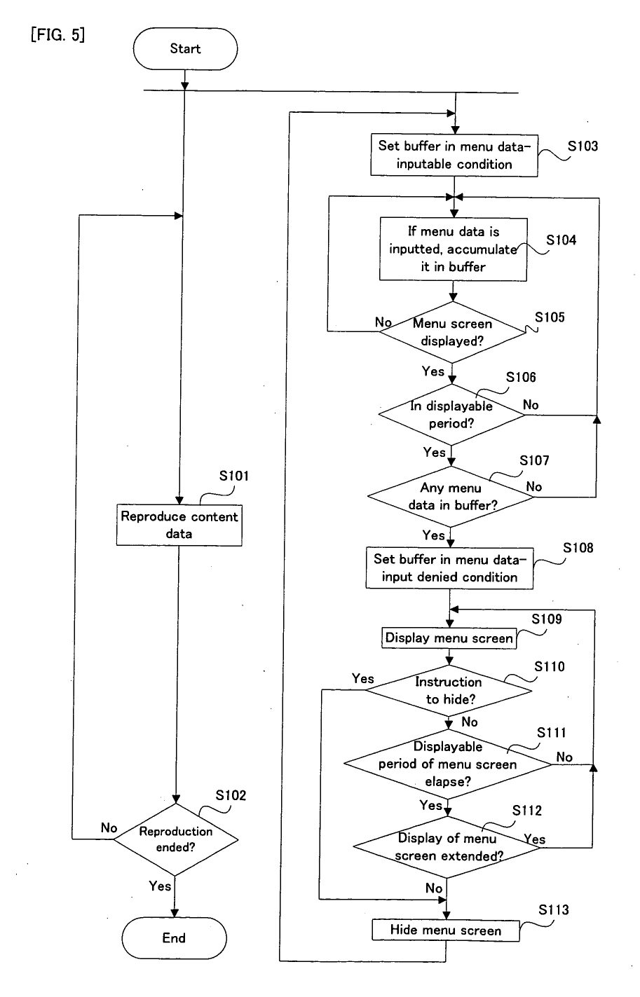

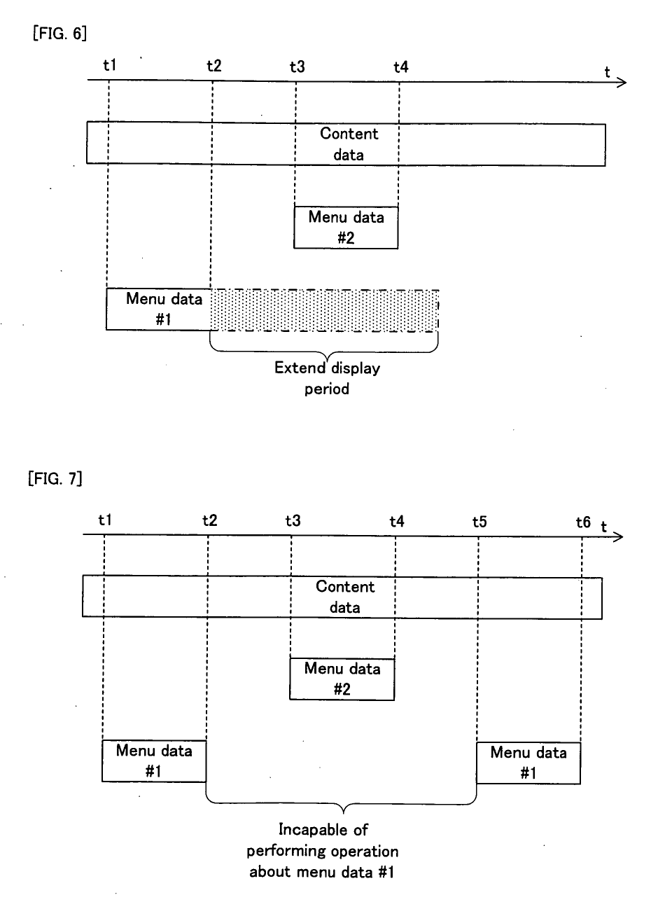

Particularly in the embodiment, by pressing the KEEP button 315, it is possible to extend the display of the menu screen. Namely, if the KEEP button 315 is pressed when the menu screen #1 is displayed, it is possible to display the menu screen #1 even in a period other than the period between the time points t1 and t2, for example. Moreover, if the KEEP button 315 is pressed when the menu screen #2 is displayed, it is possible to display the menu screen #2 even in a period other than the period between the time points t3 and t4, for example. This specific operation will be explained in detail in Operation Principle, described below (refer to FIG. 5, etc.).

Incidentally, the content data and the menu data having such a data structure can be realized as the data in a program stream (PS) or transport stream (TS) format, for example. For example, by recording the content data as a video stream, and the menu data as a sub-picture stream, it is possible to realize the optical disc 100 on which the content data or the like is recorded, capable of multiplexing and displaying the above-mentioned menu screen.

(Operation Principle)

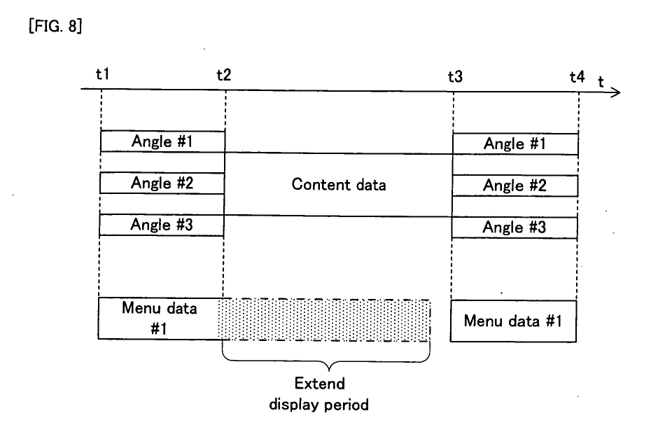

Next, with reference to FIG. 5 to FIG. 8, the menu display operation will be explained. FIG. 5 is a flowchart conceptually showing the reproduction operation including the menu display operation. FIG. 6 is an explanatory diagram conceptually showing an aspect of the menu display operation. FIG. 7 is an explanatory diagram conceptually showing an aspect of the menu display operation performed by an information reproducing apparatus in a comparison example. FIG. 8 is an explanatory diagram conceptually showing a more specific aspect of the menu display operation.

As shown in FIG. 5, the content data recorded on the optical disc 100 is reproduced (step S101). Here, predetermined content data is reproduced on the basis of the user's instruction inputted by using the operation button 310, for example. By this, a movie, a TV program, or the like, is displayed on the display 400.

Then, under the control of the CPU 354, it is judged whether or not the reproduction of the content data is ended (step S102). For example, if the reproduction of all the content data to be reproduced is ended, or an instruction to “end the reproduction” is given from the user by using the operation button 310, for example, it may be judged that the reproduction of the content data is ended.

As a result of the judgment, if it is judged that the reproduction is not ended (the step S102: No), the operational flow returns to the step S101 again, and the reproduction of the content data is continued. On the other hand, if it is judged that the reproduction is ended (the step S102: Yes), the reproduction of the content data is ended, and the optical disc 100 may be ejected from the information reproducing apparatus 300 if needed.

In parallel with the reproduction of the content data, the menu data is also reproduced. Specifically, firstly, in order the input the menu data into the buffer (specifically, the memory 355), the buffer is set in an “inputable condition” (step S103). Namely, only when the buffer is set in the “inputable condition”, the menu data can be stored into the buffer (buffering). Then, if the menu data is inputted to the buffer after the setting to the “inputable condition”, the menu data is stored into the buffer (step S104).

The menu data inputted to the buffer at this time is preferably the menu data indicating the menu screen which can be displayed in accordance with the reproduction time point of the content data. For example, it is assumed that the content data and the menu data shown in FIG. 3 are reproduced. If the content data corresponding to the time point t1 to t2 is reproduced, the menu data #1 is inputted to the buffer. If the content data corresponding to the time point t3 to t4 is reproduced, the menu data #2 is inputted to the buffer. If the content data corresponding to the time point t5 to t6 is reproduced, the menu data #1 and/or #3 is inputted to the buffer. Incidentally, if the content data corresponding to the time point t2 to t3 and the time point t4 to t5 is reproduced, the menu data which can be displayed after the time points passes, may be inputted to the buffer. For example, if the content data corresponding to the time point t2 to t3 is reproduced, the menu data #2 indicating the menu screen which can be displayed after the time point t3 passes may be inputted. Alternatively, if the content data corresponding to the time point t4 to t5 is reproduced, the menu data #1 and/or #3 indicating the menu screen which can be displayed after the time point t5 passes may be inputted. Alternatively, it is obvious that the input may be performed in other aspects, without limited to the input of the menu data.

Moreover, the menu data stored in the buffer is preferably stored in an immediately displayable condition, regardless of whether or not the menu screen is displayed on the display 400. By storing the menu data in the buffer in this manner, it is possible to immediately display the menu data as the menu screen, any time. Incidentally, the expression “immediately display” in the embodiment is a wide concept including not only a case where after the instruction to display the menu screen is inputted, the menu screen can be displayed in a short time to the extent that the user cannot recognize it, but also a case where it can be displayed in a short time to the extent that the user can allow it.

Then, it is judged whether or not the menu screen is to be displayed (step S105). Specifically, it is judged whether or not the ON button 313 is pressed by the user. If the ON button 313 is pressed, it may be judged the menu screen is to be displayed. On the other hand, if the ON button 313 is not pressed, it may be judged that the menu screen is not to be displayed.

As a result of the judgment, if it is judged that the menu screen is not to be displayed (step S105: No), the operational flow returns to the step S104 again, and the menu data inputted to the buffer in accordance with the content data to be reproduced, is stored into the buffer.

On the other hand, if it is judged that the menu screen is to be displayed (step S105: Yes), then, it is judged whether or not the current reproduction time point of the content data is in the displayable period in which the menu screen to be displayed can be displayed (step S106). For example, in the case of displaying the menu screen #2 shown in FIG. 3, if the content data corresponding to the time point t3 to t4, which is the displayable period of the menu screen #2, is reproduced, it may be judged that the current reproduction time point is in the displayable period. On the other hand, if the other content data is reproduced, it may be judged that the current reproduction time point is not in the displayable period.

As a result of the judgment, if it is judged that the current reproduction time point is not in the displayable period (the step S106: No), the operational flow returns to the step S104 again, and the menu data inputted to the buffer in accordance with the content data to be reproduced, is stored into the buffer. At this time, for example, an error screen or the like indicating that the menu screen cannot be displayed due to out of the displayable period, may be displayed on the display panel 311 or the display 400.

On the other hand, if it is judged that the current reproduction time point is in the displayable period (the step S106: Yes), then, it is judged whether or not the menu data is stored in the buffer (step S107). Here, it is particularly judged whether or not the menu data indicating the menu screen expected to be displayed from now is stored.

As a result of the judgment, if it is judged that the menu data is not stored in the buffer (the step S107: No), the menu screen cannot be displayed, so that the operational flow returns to the step S104 again, and the menu data inputted to the buffer in accordance with the content data to be reproduced, is stored into the buffer. At this time, for example, the error screen or the like indicating that the menu screen cannot be displayed because the menu data is not inputted, may be displayed on the display panel 311 or the display 400.

On the other hand, if it is judged that the menu data is stored in the buffer (the step S107: Yes), the buffer is set in an “input denied condition” in order not to input the new menu data into the buffer (step S108). By this, during the display of the certain menu screen, the menu data indicating another menu screen is not inputted into the buffer, so that it is possible to ensure the display of the proper menu screen. Namely, it is possible to avoid such a disadvantage that although the menu screen #1 is displayed (particularly, displayed with the display period extended), the menu screen #2 to be reproduced in accordance with the reproduction of the content data is displayed. In the embodiment, particularly, the operations performed in the step S105 to the step S107 are performed under the CPU 354, which is one specific example of the “detecting device” of the present invention.

Then, on the basis of the menu data stored in the buffer, the desired menu screen (e.g. refer to FIG. 4) is displayed, under the control of the CPU 354, which is one specific example of the “menu displaying device” of the present invention (step S109). Namely, the desired menu screen is multiplex-displayed, by superimposing it on the contents, such as a movie and a TV program, reproduced on the display 400. At this time, the desired menu screen may be multiplex-displayed, with it superimposed on the contents, such as a movie and a TV program, in a translucent condition.

Then, it is judged whether or not an instruction to hide the menu screen is given (step S110). Specifically, it is judged whether or not the OFF button 314 is pressed by the user. If the OFF button 314 is pressed, it may be judged that the instruction to hide the menu screen is given. On the other hand, if the OFF button 314 is not pressed, it may be judged that the instruction to hide the menu screen is not given.

As a result of the judgment, if it is judged that the instruction to hide the menu screen is given (the step S110: Yes), the menu screen is hidden (step S113). Then, the operational flow returns to the step S103, and the buffer is set in the “inputable condition” to prepare for the instruction to display the new menu screen, and then again the menu data is accumulated.

On the other hand, if it is judged that the instruction to hide the menu screen is not given (the step S110: No), then, it is judged whether or not the displayable period of the menu screen elapses (step S111). For example, in FIG. 3, when the menu screen #2 is displayed, if the reproduction of the content data has proceeded and the time point t4 has passed, it may be judged that the displayable period elapses. On the other hand, if the time point t4 has not passed, it may be judged that the displayable period does not elapse.

As a result of the judgment, if it is judged that the displayable period does not elapse (the step S111: No), the operational flow returns to the step S109 again, and the display of the menu screen is continued.

On the other hand, if it is judged that the displayable period elapses (the step S111: Yes), it is judged whether or not the instruction to extend the display of the menu screen is given (step S112). Specifically, it is judged whether or not the KEEP button 315 is pressed by the user. If the KEEP button 315 is pressed, it may be judged that the instruction to extend the display of the menu screen is given. On the other hand, if the KEEP button 315 is not pressed, it may be judged that the instruction to extend the display of the menu screen is not given.

As a result of the judgment, if it is judged that the instruction to extend the display of the menu screen is given (the step S112: Yes), the operational flow returns to the step S109 again, and the display of the menu screen is continued (or extended). On the other hand, if it is judged that the instruction to extend the display of the menu screen is not given (the step S112: No), the operational flow goes to the step S113, and the menu screen is hidden.

Then, as long as the content data is reproduced, it is preferable to perform the operation associated with the display of the menu screen, explained above.

As described above, according to the information reproducing apparatus 300 in the embodiment, even after the displayable period of the menu screen elapses, by inputting the instruction using the KEEP button 315 or the like to the information reproducing apparatus 300, it is possible to continue (or extend) the display of the menu screen. Specifically, as shown in FIG. 6, it is possible to display the menu screen #1, which can be displayed originally in only period between the time points t1 and t2, even after the time point t2 passes, on the display 400. Namely, the menu screen #2 is not displayed on the display 400, and the menu screen #1 is continuously displayed. Then, the display of this menu screen is preferably continued until the OFF button 314 is pressed, for example. However, it may be also constructed to further specify a period of extending the display of the menu screen, by using the instruction button 312. For example, if the instruction button 312 is provided with ten keys or the like, the period of extending the display may be specified as 1 minute, 5 minute, or the like. In this case, after the specified period elapses, the menu screen may be hidden.

If the content data recorded on the same optical disc is reproduced by using an information reproducing apparatus that does not have such a structure as the instruction button 312, it is not possible to display the menu screen #1 after the time point t2 passes, as shown in FIG. 7, and unless the user rewinds the content data, or waits until the time point t5 passes, the menu screen #1 cannot be displayed. If the instruction to display the menu screen is given after the time point t2 passes (e.g. if the ON button 313 is pressed), merely, the menu screen #2 is displayed between the time points t3 and t4. In any case, the menu screen #1 cannot be displayed as the user desires, so that this is an inconvenient aspect of displaying the menu screen, for the user.

However, according to the information reproducing apparatus in the embodiment, it has the instruction button 312 (particularly, the KEEP button 315), so that if the user desires to extend the display of the menu screen, it is possible to continue (extend) the display of the menu screen as the user desires. Therefore, the user can surely perform the various operations by using the menu screen, regardless of the length of the displayable period of the menu screen, indicated by the period information. In other words, without regard to the displayable period and with calmness, or without worrying about the time, the user can perform the various operations by using the menu screen. Thus, it is possible to realize the aspect of displaying the menu screen, which is easy to use or highly convenient for the user.

The more specific aspect of displaying the menu screen will be explained with reference to FIG. 8. The content data shown in FIG. 8 is constructed to reproduce the contents by selecting one desired angle from among a plurality of angles at a certain reproduction time. Specifically, as shown in FIG. 8, between the time points t1 and t2, and between the time points t3 and t4, by the user selecting the desired one angle from among three angles of an angle #1 to an angle #3, it is possible to reproduce the video images or the like associated with the selected angle.

Moreover, the menu data indicating the menu screen for selecting the angles, is recorded on the optical disc 100 with the content data, in such a condition that the displayable period is between the time points t1 and t2 and between the time points t3 and t4.

At this time, if the content data is reproduced by using an information reproducing apparatus that does not adopt such a structure as the instruction button 312, the operation about the angle change cannot be performed between the time points t2 and t3. Therefore, for example, even if it is desired to change the angle immediately before the time point t2, the menu screen is hidden as soon as the time point t2 has passed, so that the angle cannot be selected. Therefore, even if the user desires, between the time point t1 and t2 (or t3), to watch another angle after the time point t3 passes, because the menu screen can be displayed only after the time point t3 passes, the user cannot watch the video images or the like associated with the desired angle as soon as the time point t3 passes.

However, according to the embodiment, the display of the menu screen can be extended, so that it is possible to select the desired angle by using the menu screen even after the time point t2 elapses. Therefore, the user can watch the video images or the like reproduced in the desired angle which is selected as soon as the time point t3 passes.

As explained in detail with reference to FIG. 1 to FIG. 8, according to the embodiment, it has the instruction button 312 (particularly, the KEEP button 315), so that it is possible to realize the aspect of displaying the menu screen, which is easier to use or highly convenient for the user.

Incidentally, in the above-mentioned embodiment, the optical disc 100 is explained as one example of the information recording medium of the present invention, and the player associated to the optical disc 100 is explained as one example of the information reproducing apparatus of the present invention. The present invention, however, is not limited to the optical disc and the player thereof, and can be applied to other various information recording media which support high-density recording or high transfer rate, and the recorders thereof The present invention is not limited to the above-described embodiment, and various changes may be made, if desired, without departing from the essence or spirit of the invention which can be read from the claims and the entire specification. An information reproducing apparatus, an information reproducing method, and a computer program for reproduction control, which involve such changes, are also intended to be within the technical scope of the present invention.

### INDUSTRIAL APPLICABILITY

The information reproducing apparatus and method, and the computer program according to the present invention can be applied to an information reproducing apparatus, such as a DVD player, for example. Moreover, they can be applied to an information reproducing apparatus or the like, which is mounted on or can be connected to various computer equipment for consumer use or business use, for example.

1. An information reproducing apparatus for reproducing information on an information recording medium on which content information, menu information which is multiplex-displayed during reproduction of the content information, and display period information which defines a display period of the menu information are recorded,
said information reproducing apparatus comprising:
a menu displaying device for multiplex-displaying the menu information on the basis of the display period information; and
a detecting device for detecting whether the menu information is multiplex-displayed,
said menu displaying device multiplex-displaying the menu information, even after the display period defined by the display period information elapses, if it is detected by said detecting device that the menu information is multiplex-displayed.

2. The information reproducing apparatus according to claim 1, further comprising an instructing device for giving an instruction to extend the display period of multiplex-displaying the menu information,
said menu displaying device multiplex-displaying the menu information, even after the display period defined by the display period information elapses, if the instruction to extend the display period of multiplex-displaying the menu information is given from said instructing device.

3. The information reproducing apparatus according to claim 2, wherein said instructing device further gives at least an instruction to non-display the menu information which is multiplex-displayed after the display period defined by the display period information elapses.

4. The information reproducing apparatus according to claim 2, wherein said instructing device further gives an instruction relating to the display period of the menu information which is multiplex-displayed after the display period defined by the display period information elapses.

5. The information reproducing apparatus according to claim 1, further comprising a storing device for storing one menu information which is multiplex-displayed.

6. The information reproducing apparatus according to claim 5, further comprising a controlling device for controlling said storing device not to store another menu information which is to be multiplex-displayed next to the one menu information, even after the display period defined by the display period information elapses, if the display period of multiplex-displaying the menu information is extended.

7. An information reproducing method of reproducing information on an information recording medium on which content information, menu information which is multiplex-displayed during reproduction of the content information, and display period information which defines a display period of the menu information are recorded,
said information reproducing method comprising:
a menu displaying process of multiplex-displaying the menu information on the basis of the display period information;
a detecting process of detecting whether the menu information is multiplex-displayed; and
a controlling process of controlling said menu displaying process to multiplex-display the menu information, even after the display period defined by the display period information elapses, if it is detected in said detecting process that the menu information is multiplex-displayed.

8. A computer program product in a computer-readable medium for tangibly embodying a program of instructions executable by a computer provided in an information reproducing apparatus, the computer program product making the computer function as at least one portion of a menu displaying device and a detecting device,
said information reproducing apparatus for reproducing information on an information recording medium on which content information, menu information which is multiplex-displayed during reproduction of the content information, and display period information which defines a display period of the menu information are recorded,
said information reproducing apparatus comprising:
said menu displaying device for multiplex-displaying the menu information on the basis of the display period information; and
said detecting device for detecting whether the menu information is multiplex-displayed,
said menu displaying device multiplex-displaying the menu information, even after the display period defined by the display period information elapses, if it is detected by said detecting device that the menu information is multiplex-displayed.

9. The computer program product according to claim 8, wherein
said information reproducing apparatus further comprises an instructing device for giving an instruction to extend the display period of multiplex-displaying the menu information,
said menu displaying device multiplex-displays the menu information, even after the display period defined by the display period information elapses, if the instruction to extend the display period of multiplex-displaying the menu information is given from said instructing device,
said computer program product makes the computer function as at least one portion of said menu displaying device, said detecting device and said instructing device.

10. The computer program product according to claim 9, wherein said instructing device further gives at least an instruction to non-display the menu information which is multiplex-displayed after the display period defined by the display period information elapses.

11. The computer program product according to claim 9, wherein said instructing device further gives an instruction relating to the display period of the menu information which is multiplex-displayed after the display period defined by the display period information elapses.

12. The computer program product according to claim 8, wherein
said information reproducing apparatus further comprises a storing device for storing one menu information which is multiplex-displayed.

13. The computer program product according to claim 12, wherein
said information reproducing apparatus further comprises a controlling device for controlling said storing device not to store another menu information which is to be multiplex-displayed next to the one menu information, even after the display period defined by the display period information elapses, if the display period of multiplex-displaying the menu information is extended,
said computer program product makes the computer function as at least one portion of said menu displaying device, said detecting device, said instructing device and said controlling device.

14. An information reproducing apparatus for reproducing information on an information recording medium on which content information, menu information which is multiplex-displayed during reproduction of the content information, and display period information which defines a display period of the menu information are recorded,
said information reproducing apparatus comprising:
a menu displaying device for multiplex-displaying the menu information on the basis of the display period information; and
an instructing device for giving an instruction to extend the display period of multiplex-displaying the menu information,
said menu displaying device multiplex-displaying the menu information, even after the display period defined by the display period information elapses, if the display period defined by the display period information elapses and the instruction to extend the display period of multi-displaying the menu information is given by said instructing device.

15. A computer program product in a computer-readable medium for tangibly embodying a program of instructions executable by a computer provided in an information reproducing apparatus, the computer program product making the computer function as at least one portion of a menu displaying device and an instructing device,
said information reproducing apparatus for reproducing information on an information recording medium on which content information, menu information which is multiplex-displayed during reproduction of the content information, and display period information which defines a display period of the menu information are recorded,
said information reproducing apparatus comprising:
said menu displaying device for multiplex-displaying the menu information on the basis of the display period information; and
said instructing device for giving an instruction to extend the display period of multiplex-displaying the menu information,
said menu displaying device multiplex-displaying the menu information, even after the display period defined by the display period information elapses, if the display period defined by the display period information elapses and the instruction to extend the display period of multi-displaying the menu information is given by said instructing device.
